(19) United States
(12) Patent Application Publication
(10) Pub. No.: US 2004/0040148 A1
(43) Pub. Date: Mar. 4, 2004

(54) Manufacture of flexible printed circuit boards

(75) Inventors: Arthur DeMaso, Nashua, NH (US); Darryl J. McKenney, Londonderry, NH (US); Laurea J. Doiron JR., Pelham, NH (US)

Correspondence Address: WEINGARTEN, SCHURGIN, GAGNEBIN & LEBOVICI LLP, TEN POST OFFICE SQUARE, BOSTON, MA, 02109, US

(73) Assignee: PARLEX CORPORATION

(21) Appl. No.: 10/230,484

(22) Filed: Aug. 29, 2002

(51) Int. Cl. H01K 3/10; H01B 13/00; B05D 5/12

(52) U.S. Cl. 29/852; 29/847; 216/13; 427/96; 427/97

(57) ABSTRACT

A novel process is provided for the high speed fabrication of flexible printed circuit boards in continuous roll form and at a cost which is substantially less than the cost of existing fabrication processes. A web of substrate material is supplied from a roll and one or both surfaces are sputter coated with a tie-coat of Monel or chrome and a copper seed layer. The tie-coat is typically of a thickness of about 50-300 angstroms, and the copper seed layer has a thickness of about 200-4000 angstroms. Plated through holes are provided for double sided printed circuit boards, the holes being provided by laser or other suitable drilling equipment in an intended pattern on the substrate. A plating mask is provided with a negative image to allow subsequent selective electrodeposition of copper onto the unmasked areas of the substrate surfaces. The web is then passed through a continuous copper plating cell which provides a plate-up of copper on the unmasked areas of the seed layer. The web next undergoes a stripping process for the removable of the plating mask. Thereafter, a soft subtractive etching technique is employed to remove the sputtered layers of Monel and copper. Since the soft etching removes only the thin sputtered metal layer, exceptional line resolution can be achieved in a highly cost effective manner. Moreover, the process is environmentally friendly since smaller amounts of metal are removed in comparison to conventional techniques thereby minimizing the amount of waste to be disposed of.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Flexible printed circuit boards are used in a wide variety of electrical and electronic products. For many products, cost is a vital factor and the printed circuit boards must be fabricated in a low cost manner while maintaining intended reliability and performance.

Conventionally a circuit board has a relatively thick copper plating which must be removed by chemical etching, which takes a relatively long time of immersion in a etching bath and which can degrade fine circuit details intended to be formed on the board. Conventional circuit boards usually employ ½ ounce copper which has a thickness of 17 microns or 1 ounce copper which has a thickness of 35 microns. Circuit board stock having thinner copper layers typically 12, 9 and 5 microns, are available but at premium costs.

It would be beneficial to provide a circuit board having a very thin copper layer for the efficient formation of circuits having fine detail and at commercially reasonable cost.

### BRIEF SUMMARY OF THE INVENTION

The present invention provides a novel process for the high speed fabrication of flexible printed circuit boards in continuous roll form and at a cost which is substantially less than the cost of existing fabrication processes. In accordance with the novel process, a web of substrate material is supplied from a roll and is conveyed through successive stages of the processing equipment. One or both surfaces are sputter coated with a tie-coat of Monel and a copper seed layer. The tie-coat is typically of a thickness of about 50-300 angstroms, and the copper seed layer has a thickness of about 200-4000 angstroms. Plated through holes are provided for double sided printed circuit boards, the holes being provided by laser or other suitable drilling equipment in an intended pattern on the substrate. The holes are plated using known techniques to provide a conductive connection between respective substrate surfaces. A plating mask is provided with a negative image to allow subsequent selective electrodeposition of copper onto the unmasked areas of the seed layers. The plating mask is applied by lithographic printing techniques well known in the art. The web is then passed through a continuous copper plating cell or station which provides a plate-up of copper on the unmasked areas of the seed layer. After emerging from the plating cell the web undergoes a stripping process for the removable of the plating mask. Thereafter, a soft subtractive etching technique is employed to remove the sputtered layers of Monel and copper. Since the soft etching removes only the thin sputtered metal layer, exceptionally fine or thin line resolution can be achieved in a highly cost effective manner.

The novel process provides a better yield by reason of the relatively short amount of time that the circuit board remains in the etchant. An additional benefit is lower cost waste treatment since less etched copper must be removed from the board and therefore there is less etched copper to be disposed.

The process can be performed at speeds substantially higher than conventional processes. As an example, the present process can be performed at a web speed of about 200-2000 feet/minute, in contrast to a conventional process speed of about 5-6 feet/minute.

### BRIEF DESCRIPTION OF THE SEVERAL VIEWS OF THE DRAWING

The invention will be more fully described in the following detailed description in conjunction with the drawing in which:

FIG. 1 is a flow diagram of a flexible continuous roll printed circuit board process in accordance with the invention; and

FIGS. 2-5 are enlarged cross sectional diagrams of a circuit board at successive stages of the novel process.

### DETAILED DESCRIPTION OF THE INVENTION

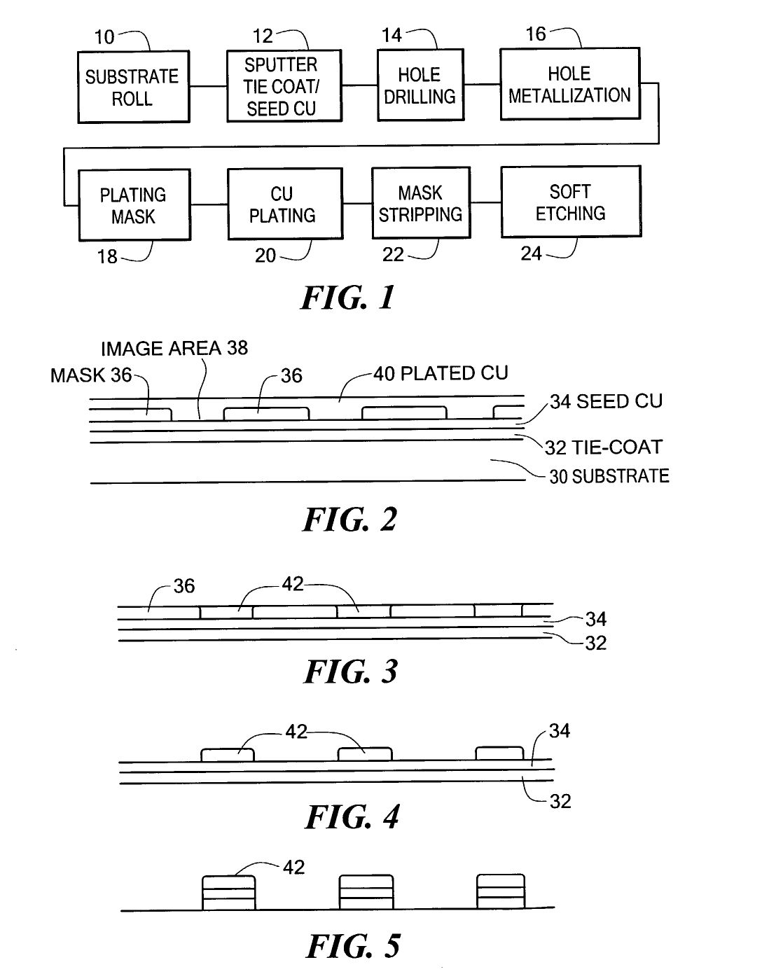

A flow chart of the process for fabricating single or double sided flexible printed circuit boards is shown in FIG. 1. A substrate roll is provided in step 10. The substrate material is preferably a flexible metal seeded dielectric such as PEN, PET, PEI and LCP. The substrate typically has a polymer thickness of 25 to 200 microns. The roll can be of a width suitable to intended purposes. Typically the roll width is in the range of about 9.84 to 18 inches. The substrate material is transported from the supply roll to a series of stations for accomplishing the process steps. The substrate is metallized on one or both surfaces in step 12 by vacuum sputtering of a metal tie-coat of 50 to 300 angstroms of Monel followed by a sputter coating of a copper seed layer to a thickness of about 200 to 4000 angstroms.

For double siding printed circuit boards with plated through holes, holes are drilled or otherwise formed through the substrate material in step 14. Holes are provided through the substrate in an intended pattern using numerically controlled drilling equipment or laser drilling equipment. The holes are plated in step 16 by a metallization process of any known type including electroless copper, electroless nickel, direct metallization or the like, to provide a conductive through connection between the surfaces of the substrate. For the fabrication of single or double sided printed circuit boards not requiring plated through holes, steps 14 and 16 are eliminated.

A plating mask is provided in step 18 with a negative image to allow subsequent selective electrodeposition of copper onto the unmasked areas. The plating mask is applied by lithographic printing techniques to one or both surfaces of the metallized substrate. The substrate is next copper plated in continuous roll form in step 20 to deposit an appreciable thickness of copper onto the unmasked areas of the sputtered copper layer. The plated layer is typically of a thickness of about 2 to 50 microns. For fine line circuits, the plating range is typically about 2.5 to 25 microns. A mask stripping operation is performed in step 22 to remove the plating mask and reveal the underlying sputtered layer of copper/Monel. Stripping chemistries can be of known form using existing formulations of water and sodium hydroxide, potassium hydroxide or alkanolamines. A soft etching process is next provided in step 24 in which the sputtered layers of Monel and copper are chemically removed to yield an etched detail or circuit pattern on the substrate. The chemicals used for the soft etching are consistent with existing copper etching technology as known in the printed circuit board industry. This soft etching can include for example water and sodium persulfate, pottasium persulfate, hydrogen peroxide and sulfuric acid mixtures, or peroxymonosulfates. By soft etching is meant a etching process which need not remove large quantities of metal as is typical in subtractive etching techniques used in conventional printed circuit board manufacturing processes. The etching of only the thin sputtered metal layer allows for exceptionally fine line resolutions and a highly cost effective technique which can be accomplished in an environmentally friendly method.

The process is performed in continuous roll form at speeds substantially higher than that of conventional circuit board manufacture. The novel process can operate at a substrate or web speed of about 15 to 25 feet per minute, in contrast to conventional process which typically operate at about 1 to 6 feet per minute. The cost of the novel process is also substantially less than conventional process and can be for example, one tenth the cost of conventional processes.

Enlarged cross sectional views of a circuit board at successive stages of the novel process are illustrated in FIGS. 2-5. Referring to FIG. 2 there is shown a substrate 30 having formed thereon a tie-coat 32 of Monel or chrome. A copper seed coat 34 is provided over the tie-coat 32. A plating mask 36 is provided over the seed coat and having negative image areas 38 which define the circuit pattern being formed. A copper layer 40 is plated over the mask and exposed image areas.

The excess copper plated over the mask areas is removed to leave the copper plated image areas 42 as shown in FIG. 3. The mask 36 is stripped from the board to leave the copper plated areas 42 as shown in FIG. 4. The tie-coat and copper seed coat are next removed by a soft etching process as described above to provide the plated circuit as shown in FIG. 5.

For a double sided circuit, the same steps are employed for both surfaces of the substrate. Plated through holes can be provided as described above for selective interconnection of conductive traces on the top and bottom surfaces of the board.

The invention is not to be limited by what has been particularly shown and described but is to embrace the full scope and spirit of the appended claims.

What is claimed is:

1. A method for fabricating a flexible printed circuit board comprising the steps of:
providing a web of flexible substrate material;
sputtering a metal tie-coat to at least one surface of the substrate material;
sputtering a copper seed layer to the metal tie-coat;
printing a negative plating mask on the copper seed layer to form an intended mask pattern;
copper plating the unmasked areas of the copper seed layer to a predetermined thickness;
stripping the plating mask from the substrate; and
soft etching the sputtered copper/tie-coat to remove the copper/tie-coat material.

2. The method of claim 1 wherein the step of sputtering a metal tie-coat comprises sputtering a metal tie-coat to both surfaces of the substrate material; and
wherein the subsequent steps are accomplished for both surfaces of the substrate material.

3. The method of claim 2 including the steps of:
providing holes through the substrate in an intended pattern; and
metallizing the holes to provide a conductive through connection between the surfaces of the substrate.

4. The method of claim 1 wherein the substrate material is selected from the group consisting of PEN, PET, PEI and LCP.

5. The method of claim 1 wherein the metal tie-coat is sputtered Monel.

6. The method of claim 1 wherein the metal tie-coat is sputtered to a thickness of about 50 to 300 angstroms.

7. The method of claim 1 herein the copper seed layer is sputtered to a thickness of 200 to 4000 angstroms.

8. The method of claim 1 wherein the substrate has a thickness of about 25 to 200 microns.

9. The method of claim 1 wherein the copper plating over the seed layer is of a thickness of about 2 to 50 microns.

10. A method for fabricating a flexible printed circuit board comprising the steps of:
providing a web of flexible substrate material having first and second surfaces;
providing holes through the substrate in an intended pattern;
metallizing the holes to provide a conductive through connection between the surfaces of the substrate;
sputtering a metal tie-coat to each surface of the substrate material;
sputtering a copper seed layer to each metal tie-coat;
printing a negative plating mask on at least one copper seed layer to form an intended mask pattern;
copper plating the unmasked areas of the copper seed layer to a predetermined thickness;
stripping the plating mask from the substrate; and
soft etching the sputtered copper/tie-coat to remove the copper/tie-coat material.

11. A method for fabricating a flexible printed circuit board in continuous roll form comprising the steps of:
supplying a web of flexible substrate material from a roll of such material;
conveying the web of flexible substrate material through successive processing stages;
sputtering a metal tie-coat to at least one surface of the substrate material;
sputtering a copper seed layer to the metal tie-coat;
printing a negative plating mask on the copper seed layer to form an intended mask pattern;
copper plating the unmasked areas of the copper seed layer to a predetermined thickness;
stripping the plating mask from the substrate; and
soft etching the sputtered copper/tie-coat to remove the copper/tie-coat material.

12. The method of claim 11 including the steps of:
providing holes through the substrate in an intended pattern; and
metallizing the holes to provide a conductive through connection between the surfaces of the substrate.

13. The method of claim 11 in which the web is conveyed at a speed of about 200-2000 feet/minute.

14. The method of claim 11 in which the web has a width of about 10-18 inches.
